(19) United States
(12) Patent Application Publication
(10) Pub. No.: US 2026/0350254 A1
(43) Pub. Date: Nov. 5, 2026

(54) MULTI-OBJECTIVE PRODUCTION METHOD FOR EFFICIENT AIRFOIL GEOMETRIES FOR USE IN ROTORCRAFT IN LOW REYNOLDS CONDITIONS

(71) Applicant: United States of America as represented by the Administrator of NASA, Washington, DC (US)

(72) Inventors: Witold Johannes Folgert Koning, Moffett Field, CA (US); Brenda Natalia Perez Perez, Moffett Field, CA (US); Haley V. Cummings, Moffett Field, CA (US); Ethan A. Romander, Moffett Field, CA (US); Wayne Johnson, Moffett Field, CA (US)

(21) Appl. No.: 19/531,662

(22) Filed: Feb. 6, 2026

Related U.S. Application Data
(60) Provisional application No. 63/754,494, filed on Feb. 5, 2025.

(51) Int. Cl. G06F 30/15

(52) U.S. Cl. CPC G06F 30/15

(57) ABSTRACT

A computer-implemented method for determining multi-objective optimized airfoil geometries and rotor geometries is described. The process employs a ROAMX parameterization that allows for efficient airfoil parameterization and evaluation at low Reynolds numbers: discontinuities along the airfoil profile can be readily explored, thickness can be specified if so desired, and the curve order of the camber or thickness segments can be adjusted in order to limit the number of design variables.

### ORIGIN OF INVENTION

The invention described herein was made in the performance of work under a NASA contract and by (an) employee(s) of the United States Government and is subject to the provisions of Public Law 96-517 (35 U.S.C. § 202) and may be manufactured and used by or for the Government for governmental purposes without the payment of any royalties thereon or therefore. In accordance with 35 U.S.C. § 202, the contractor has elected not to retain title.

### FIELD OF THE INVENTION

The present disclosure relates generally to multi-objective optimization and, more particularly, to methods and systems for producing efficient airfoil geometries for use in rotorcraft in low Reynolds conditions.

### BACKGROUND OF THE DISCLOSURE

The rotor aerodynamics for flying rotorcraft on Mars must overcome the challenges of a low density and low temperature surface atmosphere. The low density of the Martian atmosphere and the relatively small-scale rotor on a launch-and-landing-feasible rotorcraft, such as the NASA Mars Helicopter Ingenuity, result in air flows with very low Reynolds numbers, reducing the lifting force and lifting efficiency.

While Ingenuity made history in April 2021 for being the first aircraft to execute powered, controlled flight on another planet, further rotor optimization would enhance flight performance of such aircraft, resulting in longer flight durations for limited on-board power.

Accordingly, methods and systems for efficiently and effectively optimizing rotor airfoils by computational optimization are desirable.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a computer-implemented method for the Evolutionary algorithm for Iterative Studies of Aeromechanics (ELISA) is provided. [MIRROR CLAIM LANGUAGE]

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic view of an example of a system for producing efficient airfoil geometries, according to one or more embodiments consistent with the present disclosure.

FIG. 2 is a schematic view of an example of a system for multi-objective airfoil optimization using a continuous genetic algorithm to create a Pareto-optimal set of airfoil geometries, according to one or more embodiments consistent with the present disclosure.

FIG. 3 is a schematic view of an example of a system for multi-objective rotor optimization using a continuous genetic algorithm to create a Pareto-optimal rotor set, according to one or more embodiments consistent with the present disclosure.

FIG. 4 illustrates an example of a computer-implemented method for producing efficient airfoil geometries for use in rotorcraft, according to one or more embodiments consistent with the present disclosure.

FIG. 5 is a schematic cross-section view of an example of a Pareto-optimal airfoil produced by multi-objective airfoil optimization using ROAMX-1301 parametrization, according to one or more embodiments consistent with the present disclosure.

FIG. 6 is a schematic cross-section view of an example of a Pareto-optimal airfoil produced by multi-objective airfoil optimization using ROAMX-0201 parametrization, according to one or more embodiments consistent with the present disclosure.

FIG. 10 illustrates an example of a computer system that can be employed to execute one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to multi-objective optimization and, more particularly, to methods and systems for producing efficient airfoil geometries for use in rotorcraft in low Reynolds conditions.

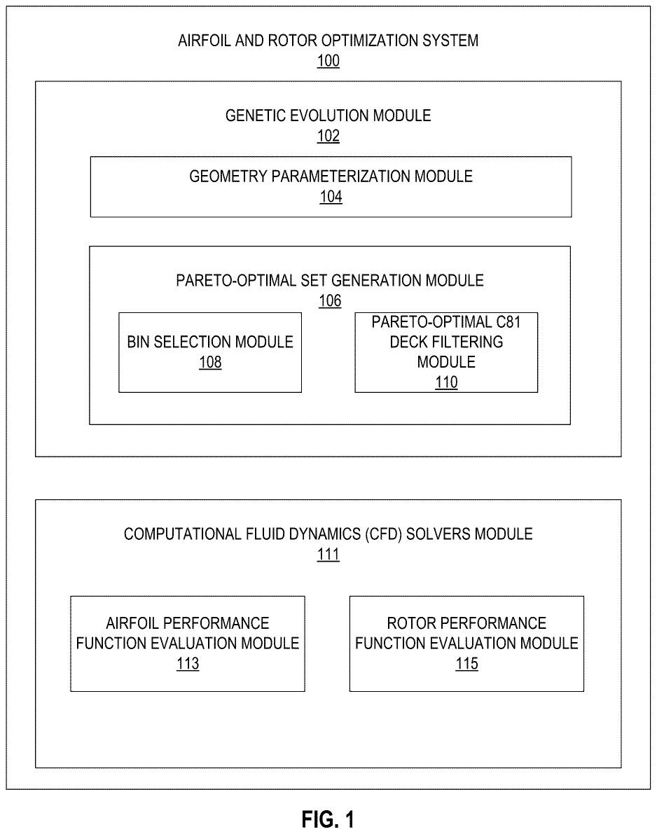

FIG. 1 is a schematic view of an example system 100 for producing efficient airfoil geometries, according to one or more embodiments consistent with the present disclosure. While in the figure, the modules may be shown as grouped within another module, it is understood that those of skill in the part that the modules may be separated or grouped in different arrangement without departing from the spirit of the invention.

The system 100 can be utilized in the creation of Pareto-optimal airfoil sets and Pareto-optimal C81 decks of airfoils that are further filtered and optimized to create a Pareto-optimized rotor sets and planform. In some embodiments, the system 100 can utilize a genetic evolution module 102 to iteratively and heuristically optimize simultaneously for two or more objectives, such as minimize drag and maximize lift, resulting in a Pareto-optimal airfoil set. Another objectives, such as airfoil thickness ratio or other structural objective, or flow dynamic conditions such as operation in flows at a low Reynolds number, can also be specified as an optimization objective.

With further reference to FIG. 1, geometry parameterization module 104 receives input of the desired parameterization for the set of airfoils to produce. Airfoil geometry can be expressed by camber and thickness parameterization, with a number of Bézier nodes that are distributed between the leading edge (LE) and the trailing edge (TE) of the airfoil cross-section of the rotor blade. Geometry parameterization module 104 connects these nodes, starting at the LE, by curves as function of chord until the TE is reached. The lines connecting the nodes are represented by Bezier curves which can be chosen to be of first, second, or third order. Geometry parameterization module 104 combines for each airfoil, the camber, thickness, and a baseline thickness are combined to yield the final airfoil geometry.

To more effectively evaluate unconventional airfoil shapes while keeping the number of decision variables to a minimum, the Rotorcraft Optimization for the Advancement of Mars Exploration (ROAMX) parameterization was developed. The ROAMX parameterization allows for efficient airfoil parameterization and evaluation at low Reynolds numbers: discontinuities along the airfoil profile can be readily explored, thickness can be specified if so desired, and the curve order of the camber or thickness segments can be adjusted in order to limit the number of design variables.

The airfoil optimization is performed for each radial station in parallel. The airfoil parameterization can be set to ‘roamx’ (dual objectives: maximization of cₗ and minimization of c_{d}) or ‘roamx3’ (‘roamx’ objectives and maximization of a structural metric or Reynolds number). Geometry parameterization module 104 computes the structural properties of the airfoil profiles each iteration of the genetic evolution, and include profile thickness t/c or (t/c)², or the profile's second moment of area over the chord line. In examples here, t/c is pursued. If ‘roamx3’ optimization is performed, an upper and lower bound of the structural metric can be selected to constrain the optimization to useful values of the structural metric. A desired minimum cₗ/c_{d} threshold is set to avoid optimizing for stalled conditions (which are non-physical in 2D and of limited use), but optionally low cₗ values can be included in the Pareto-optimal airfoil selection procedure.

In some embodiments, ROAMX parameterization is notated in terms of a prefix ‘roamx-’ to indicate dual-objective optimization, or ‘roamx3-’ to indicate triple-objective optimization, for use by system 100 for a given optimization. The prefix is followed by four digits, with the first set of two digits indicating camber parameters, such as the number of camber nodes and the order of Bézier curve segments, and the second set of two digits indicating thickness parameters, such as the number of thickness nodes, and the order of Bézier curve segments for thickness.

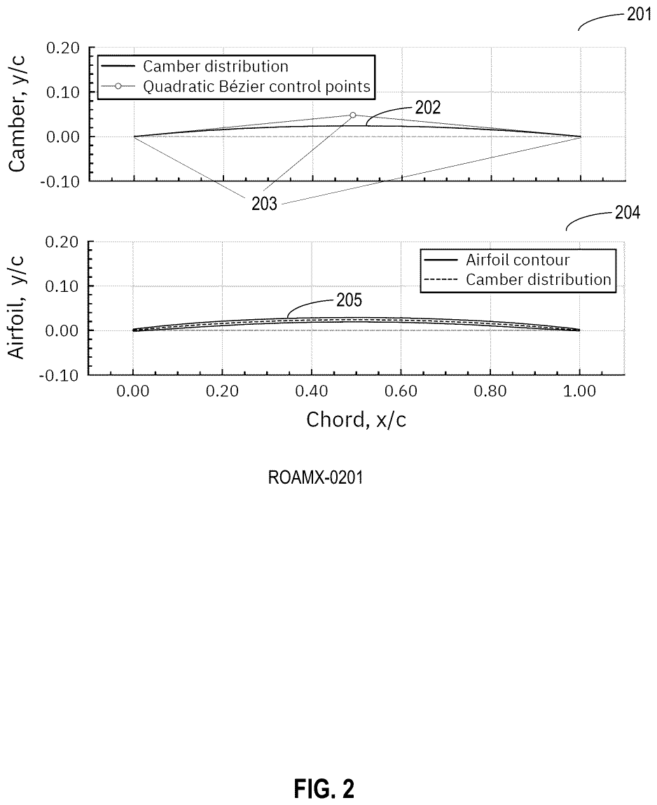

For example, FIG. 2 illustrates an example of ‘roamx-0201’ parameterization, specified to geometry parameterization module 104 using 3 decision variables—angle of attack and the two coordinates of the quadratic Bézier control points. In this example, ‘roamx-0201’ is specified with no camber nodes (0), quadratic Bézier control points for second order Bézier curve segments (2), no specified thickness (0) indicating a geometry where baseline thickness applies instead, and linear control points for first order (1) Bézier curve. The upper graph 201 illustrates the camber distribution 202 and the quadratic Bézier control points 203 for a possible airfoil in the ‘roamx-0201’ parameterization solution space. The lower graph 204 illustrates the airfoil contour 205 around the camber distribution 202 given a specified baseline minimum thickness when no thickness parameters are set (‘01’).

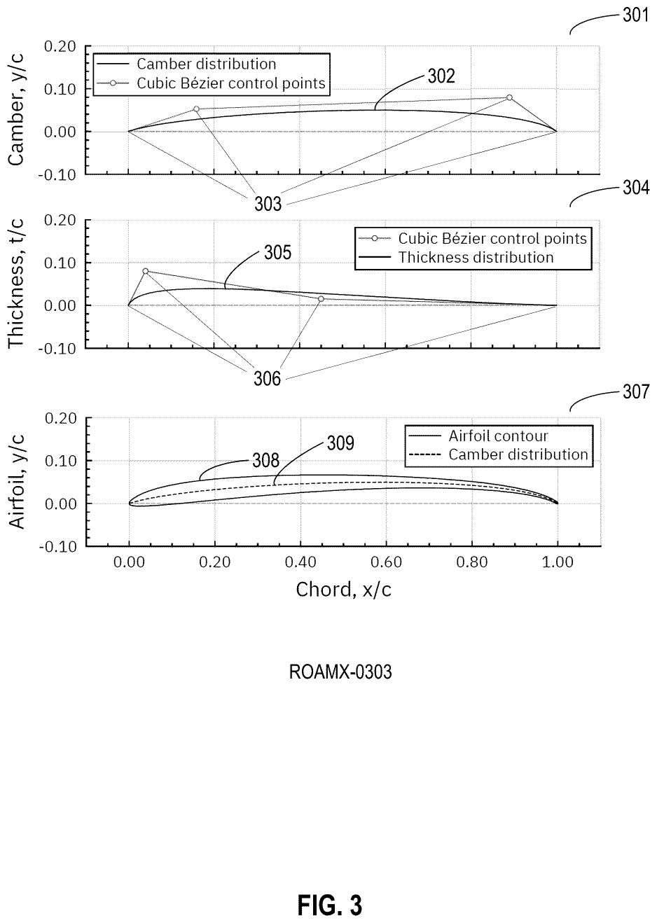

FIG. 3 illustrates an example of ‘roamx-0303’ parameterization, specified using 9 decision variables—angle of attack and two pairs of Bézier control points for both thickness and camber. ‘roamx-0303’ with no camber nodes (0), quadratic Bézier control points for cubic order Bézier curve segments (3), no thickness (0) (baseline thickness applies), and quadratic control points for first order (1) Bézier curve segments. The upper graph 301 illustrates the camber distribution 302 and the cubic Bézier control points 303 for a possible airfoil in the ‘roamx-0303’ parameterization solution space. The middle graph 304 illustrates the thickness distribution 305 and the cubic Bézier control points 306 for thickness. The lower graph 307 illustrates the airfoil contour 308 around the camber distribution 309.

In some embodiments, a feature of the ROAMX parameterization scheme provides the advantage to allow an input of an arbitrary combination of camber and thickness nodes and curve order, allowing for discontinuities along the airfoil profiles, so that unconventional profiles can be investigated within the solution space.

In some embodiments, genetic evolution module 102 can receive inputs to be used when running the aerodynamic evaluations of airfoil geometries for the optimization process, such as primary flight conditions for the rotor. The conditions the tip Mach number, Mₜᵢₚ, and location-based conditions (atmospheric density, temperature, dynamic viscosity). As the objective of the code is rotor hover optimization, no tradeoffs with cruise speed will be considered and Mₜᵢₚ is therefore specified as an input. This avoids optimization up to drag-divergence Mach numbers (and thereby strongly limiting any forward flight speed, M_{cruise}). The tip Mach number is partially estimated by the drag divergence characteristics, M_{dd}, in the aerodynamic regime of interest. In general, it is desired to ensure that Mₜᵢₚ+M_{cruise}<<M_{dd}.

With reference to FIG. 1, geometry parameterization module 104 also receives input of the desired rotor parameterization for the rotor set produced.

In some embodiments, genetic evolution module 102 can receive inputs to be used when running the rotor segment optimization. The inputs include the rotor radius, rotor root cutout, the radial stations at which airfoil optimization is to be performed, and the corresponding chord estimates at those radial stations. The chord estimates will lead to the Reynolds number estimates for each airfoil, combined with the operating condition from the previous input. The rotor chord and twist can both be optimized and are either not parameterized (individual values per radial station), or use a linear, quadratic, or cubic Bézier curve for their parameterization. Radial locations at which negative taper and twist with increased radial location are required can be set. The rotor optimization has dual objectives: maximization of blade loading, which is defined as coefficient of thrust (C_{T}) over thrust-weighted solidity (σ), C_{T}/σ, and simultaneous minimization of rotor power, which is defined as, coefficient of rotor power (C_{P}) over thrust-weighted solidity (σ), C_{P}/σ. In some embodiments, genetic evolution module 102 receives a configuration to set s minimum C_{T}/C_{P} ratio to avoid generating designs at very low lift or installed conditions, but low-thrust solutions can be kept in the Pareto-optimal rotor selection procedure if so desired.

Genetic evaluation module 102 also operates Pareto-optimal set generation module 106 to iteratively generate and select airfoil geometries and rotor geometries from a search space that are fitter than others, and re-iterating the process of selection until the Pareto optimal set converges at a Pareto front. The airfoil optimization produced by airfoil and rotor optimization system 100 aims to simultaneously minimize section drag (c_{d}) and maximize section lift (cₗ), resulting in a Pareto-optimal airfoil set. In some embodiments, a third objective is introduced into the optimization process, for example, a maximization of airfoil thickness ratio, t/c, or other a structural metric, or Reynolds number.

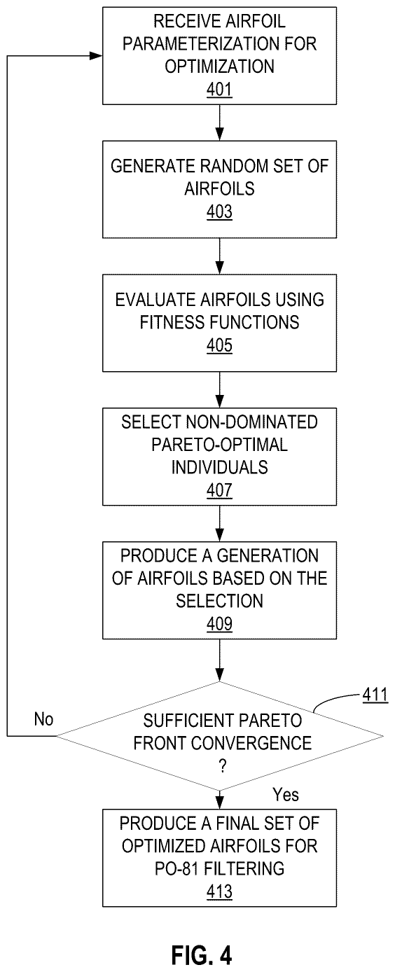

Pareto-optimal set generation module 106 operates a process to search a design space iteratively and heuristically. In some embodiments, the search process is a genetic algorithm (GA). FIG. 4 illustrates an example of a computer-implemented method for producing efficient airfoil geometries for use in rotorcraft, according to one or more embodiments consistent with the present disclosure. The process begins at step 401, where a particular ‘roamx’ or ‘roamx3’ parameterization is received as input for performing optimization, which reflect decision variables such as the number and order of Bézier control points for thickness and the number and order of Bézier control points for camber.

At step 403, a set of airfoils are randomly generated according to its decision variables, such as an angle of attack, Bézier control points for both thickness and Bézier control points for camber. Thus, it can be thought that the decision variables are metaphorically the genes of the set of airfoils, produced according to the decision variables, like how biological organism are produced according to their genes. The airfoils are ‘individuals’ in the biological metaphor, forming a ‘population’ of sets of airfoils. Each iteration of the process produces a ‘generation’ of airfoils.

At step 405, each airfoil is evaluated using fitness functions that evaluate the degree to which performance targets are met, including aerodynamic performance targets, structural metrics such as thickness, and Reynolds number targets. Examples of fitness functions include fitness for lift fₗ, as shown in Equation 1, fitness for drag f_{d}, as shown in Equation 2, and fitness for thickness fₜ, as shown in Equation 3.

$${f}_{l} = {( 1 - \frac{{c}_{l}}{{c}_{l}^{*}} )}^{2} \qquad ( 1 )$$

$${f}_{d} = {( 1 - \frac{{c}_{d}^{*}}{{c}_{d}} )}^{2} \qquad ( 2 )$$

$${f}_{t} = {( 1 - \frac{t / c}{{t}^{*}} )}^{2} \qquad ( 3 )$$

where cₗ is the coefficient of lift, c_{d} is the coefficient of drag, t is airfoil thickness, c is chord length, where

$${c}_{l}^{*} ,$$

is a high (unattainable) reference lift coefficient,

$${c}_{d}^{*}$$

is a low (unattainable) reference drag coefficient, and t* is an unattainable reference thickness. The Airfoil performance function evaluations are performed using 2D Computational Fluid Dynamics (CFD), which will be further described below.

At step 407, non-dominated, Pareto-optimal individuals are selected for possible modification, and for advancement to the next iteration.

At step 409, in some embodiments, genetic operators are applied to the set, such as (1) passthrough, which allows a fit individual to move to the next generation unmodified, (2) random average crossover, which averages all the variables of two randomly sampled nondominated individuals, (3) perturbation mutations, which are mutations according to a probability of perturbation that can be inputted into bin selection module 108, and (4) mutation, which are specific probability of complete mutation per variable, which can be inputted into bin selection module 108. A next generation of airfoils are produced at the end of step 409.

The process is repeated for steps 405, 407, and 409 on the next generation of airfoils produced. As the process repeats, the new generations selected and produced would converge along a Pareto front. The process is terminated after ensuring convergence of the Pareto front length at step 411. The process generates a Pareto-optimal set which contains the lowest section drag airfoil geometry for each attainable section lift coefficient. In processes executed on ‘roamx3’ parameterization, a Pareto-optimal set can be selected for a particular specified thickness between upper and lower bounds.

In some embodiments, especially for triple-objective problems, a bin selection procedure identifies individuals that meet the fitness target to advance to the next generation. For dual objective parameterization, distances (lengths) between adjacent points along the Pareto front is determined. The selection procedure then first picks the solutions at the endpoints of the Pareto front, and then follows by uniquely sampling the points with the biggest ‘gaps’ in the Pareto front first, until the population size for a generation is met. This approach greatly promotes an even distribution along the Pareto front. Furthermore, if an individual is found with a relatively large fitness improvement compared to its neighbors, this procedure equivalently ensures that the fit individual is sampled more frequently due to its distance to its neighbor, propagating the genetic information more frequently as long as the relative advantage (i.e., gap) prevails. This method is used for dual objective problems with 2D Pareto-optimal sets.

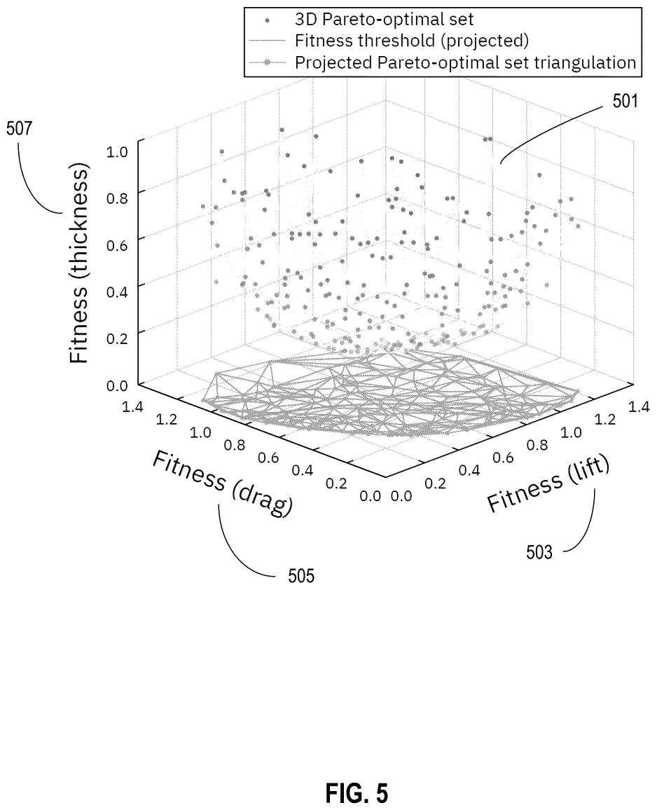

For 3D Pareto-optimal sets, FIG. 5 is a graph representing a set of Pareto-optimal airfoils 501 based on fitness values for lift 503, drag 505, and thickness 507. A shown in FIG. 5, the Pareto-optimal front has a shell- or bowl-like shape. In an improvement over prior bin-selection procedures, airfoil and rotor optimization system 100 and bin selection module 108 computes distances between neighbors in three dimensions. A triangulation is performed on the 3D dataset to create a 3D surface. A 2D-projection of the triangulation onto the lift and drag plane is generated. The Pareto-optimal set is reduced to triangles which have at least one of their vertices within the aerodynamic performance threshold (cₗ/c_{d} ratio) and within the lower and upper thickness thresholds. The area of the triangles thus defined and selected in the 3D Cartesian system is calculated. The triangles and the vertices (nodes) that are the Pareto-optimal airfoils (individuals) in the set is ordered from large to small. Unique nodes are listed and ordered, allowing allows for the selection of individuals in three-objective space until the population size is met for a generation.

Using the individuals converged on the Pareto front generated via the genetic evolution process described in FIG. 4, the airfoil and rotor optimization system 100 can further utilize a computational fluid dynamics (CFD) solver 111 at step 405 for evaluating performance functions. The CFD solver 111 can be a readily-available software package (e.g., the National Aeronautics and Space Administration's OVERFLOW 2.3d, which is a implicit, compressible Navier-Stokes solver) or can be a custom, proprietary, or commercially-available CFD solver. The CFD solver 111 can use 2D CFD with structured grids.

The CFD solver 111 utilizing the airfoil performance function evaluation module 113 can receive inputs for the airfoil optimization to provide full flexibility to adjust the simulations for the aerodynamic regime of interest. Laminar Unsteady Navier-Stokes (UNS) equations and no turbulence model can be employed. This approach attempts to resolve the flow down to the grid resolution, leaving scales below the grid level (in time or space) unevaluated. Simulations can be set up using a set of coarse timesteps at first to remove the initial transients before starting the time-accurate runs. During post processing, the transients of the time-accurate part of the simulations are evaluated to remove them from the computation of the mean and compute the corresponding confidence intervals.

The location of the airfoil's leading edge (LE,) Bézier nodes, and trailing edge (TE) are provided to the grid generation script which automatically refines the chordwise spacing around discontinuities in the grid. Airfoils are generated as a basic grid, but the maximum chordwise and off body separation was set at 1% of the chord c to reduce the grid size and computation time. The dimensionless wall distance is kept below y+=1 for all cases. Grid dimensions vary between different analyses presented in this work, but the grid dimensions are on the order of 1,000 chordwise and 250 normal grid points.

The airfoil function evaluation is the constraining element of the workflow for optimization. The airfoil optimization code automatically distributes each ‘chromosome’ defining an individual airfoil to a dedicated node on the Pleiades Supercomputer at NASA Ames Research Center to compute the whole generational fitness in parallel to efficiently advance the solutions. In some instances, the average solution advance required approximately 45 minutes of wall time per generation, and the majority of the Pareto-fronts are well-defined after around 50 to 100 generations.

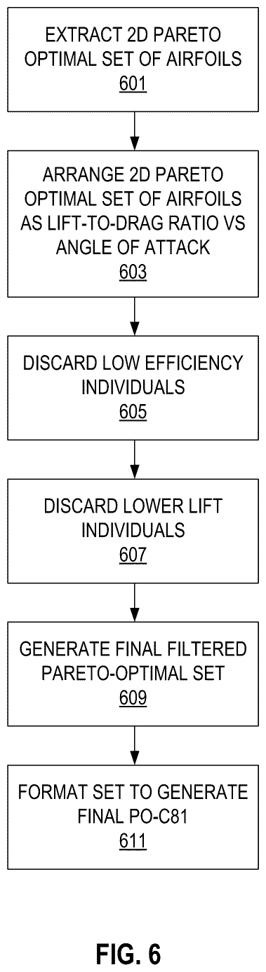

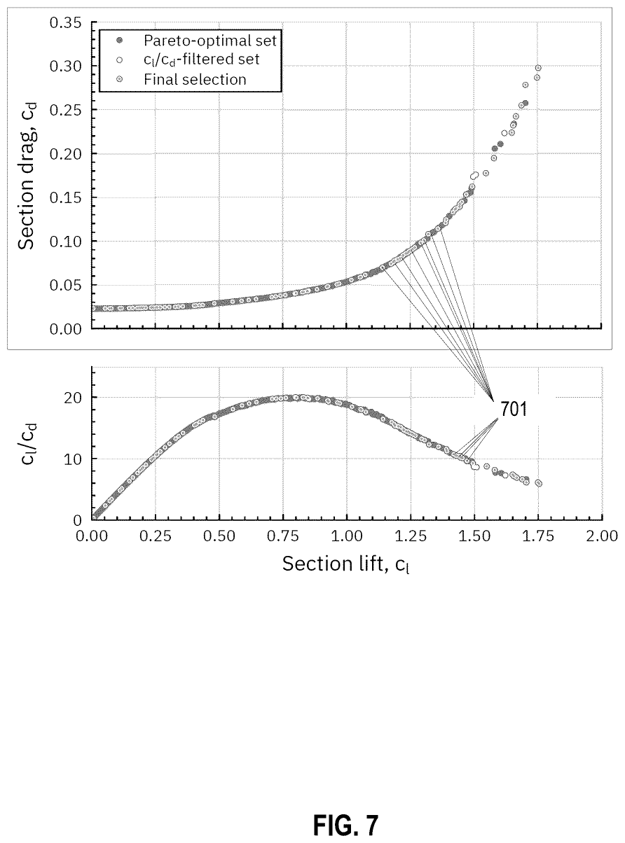

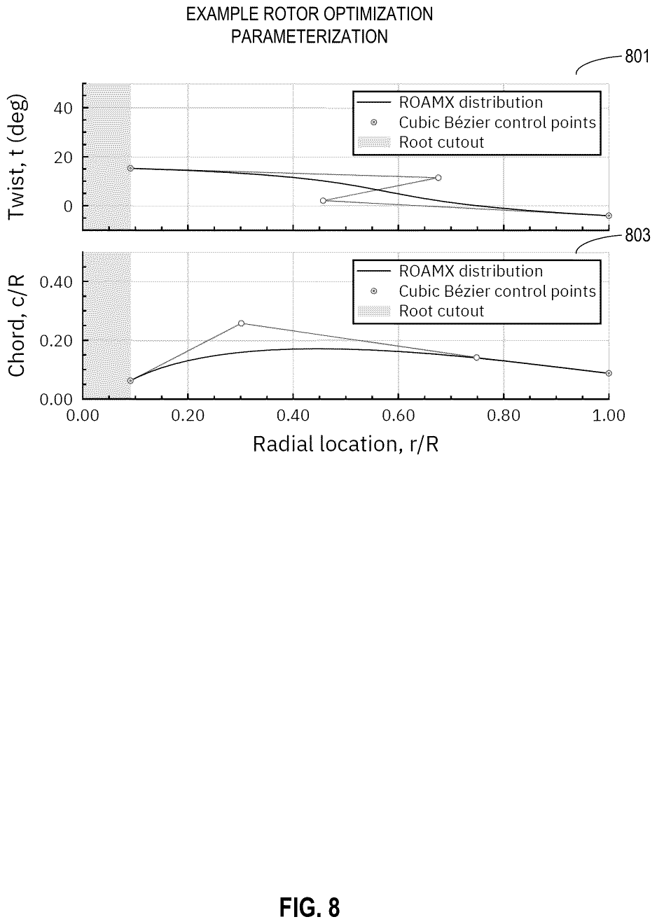

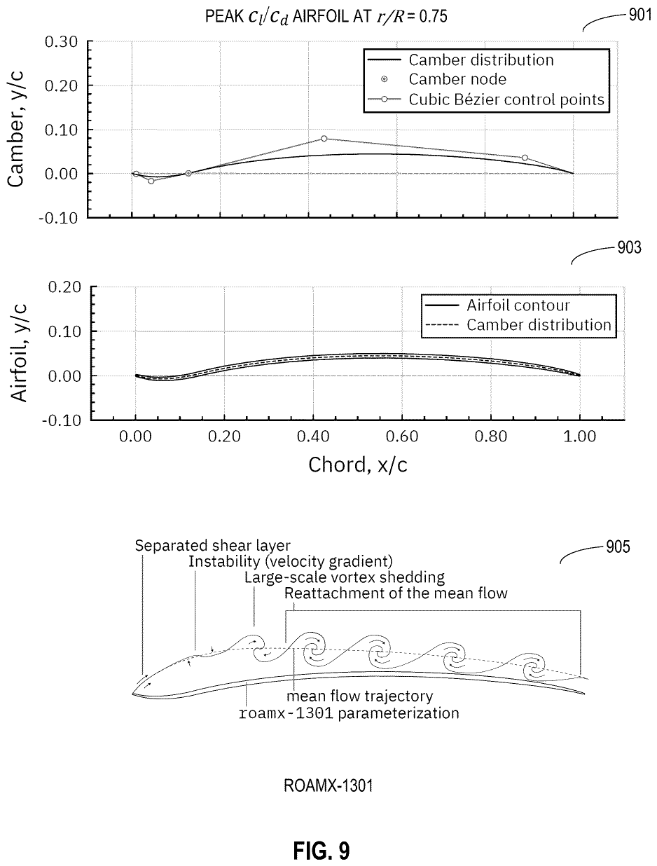

Once airfoil optimization is completed, airfoils of the Pareto-optimal sets generated at the end of the process described with reference to FIG. 4 are re-configured in the format of “C81 decks,” and filtered as Pareto-optimal C81 (PO-C81) decks, with reference to FIG. 6, a flow diagram illustrating a process for generating a PO-C81 deck by filtering, according to some embodiments. C81 was an early rotorcraft comprehensive analysis program, for which the format was defined. C81 deck files are a specific format of text files of airfoil lift, drag, and moment coefficients, as a function of angle of attack and Mach number.

In some embodiments, a ‘roamx3’-type optimization is pursued, and at step 601, the 3D Pareto-optimal set (function of coefficient of lift (cₗ), coefficient of drag (c_{d}), and thickness relative to chord length (t/c)) is first used to extract a 2D Pareto optimal set by evaluating Pareto-optimality subjected to the desired thickness constraint. At step 603, the 2D Pareto-optimal airfoil set is now arranged as section lift-to-drag ratio versus angle of attack (a decision variable for all airfoil optimizations).

Next, at step 605, lower efficiency individuals are discarded by enforcing a strict unimodal (i.e., having only a single highest value) lift-to-drag ratio distribution with angle of attack. Any near-duplicate angles of attack, for example, those which are same by two decimal places, are removed here to avoid ambiguity since angle of attack is used to trace back the airfoil geometries in the rotor optimization phase. The reduced Pareto-optimal set is now ordered as section lift versus angle of attack.

At step 607, the filter now discards lower lift individuals by enforcing a strict unimodal section lift distribution with angle of attack. At step 609, the final Pareto-optimal set 701 (pointing to a subset of some of the green individuals selected) is now generated in FIG. 7

In some embodiments, the selection of the Pareto-optimal airfoil set is now finally reduced if the set contains more than the allowable 99 angle of attack entries in a C81 deck. Reduction is implemented by eliminating individuals that are closest to their nearest neighbors in terms of angle of attack. As the filtered Pareto-optimal set now has a unimodal section lift with respect to angle of attack while keeping the most efficient geometries, the set can now be formatted into proper PO-C81 decks for each radial station.

After airfoil optimization, the airfoils are analyzed as a rotor planform to perform rotor optimization utilizing the airfoil and rotor optimization system 100 and genetic evolution module 102, mirroring the approach taken in airfoil optimization. The objectives for rotor optimization are twofold: maximization of blade loading, which is defined as coefficient of thrust (C_{T}) over thrust-weighted solidity (σ), C_{T}/σ, and simultaneous minimization of rotor power, which is defined as, coefficient of rotor power (C_{P}) over thrust-weighted solidity (σ), C_{P}/σ, ultimately yielding a Pareto-optimal rotor set. The Pareto-optimal set represents the lowest power rotors across all achievable blade loadings.

Similar to airfoil parameterization, rotor parameterization closely mirrors the ROAMX airfoil optimization and is designed to parameterize both the twist and planform of the rotor. The same genetic operators are used to modify each generation. The user can specify ‘no parameterization’ (i.e., each chord and twist value is allowed to individually vary) or a linear, quadratic, or cubic Bézier curves may be used to represent the twist and chord. FIG. 8 is a pair of graphs showing an example twist 801 and chord 803 parameterization using cubic Bézier curves in rotor optimization, according to some embodiments.

The user can set limits to the chord and twist slopes in the outboard region to help converge to realistic rotor geometries. Furthermore, the user can choose to optimize rotor planform while fixing the thrust-weighted solidity numerically. The root and tip node radial locations are fixed, but the chord and twist values are free (in contrast to the airfoil parameterization where the LE and TE points are fixed). These constraints result in the rotor parameterization in FIG. 8 having 12 decision variables (two pairs of coordinates for the cubic Bézier curves, 2 root values, and 2 tip values). The collective is fixed during the optimization, being redundant with twist.

In some embodiments of the invention, rotor performance function evaluation module 115 performs the rotor performance function evaluations using a Comprehensive Analyses (CA) code, such as the Comprehensive Analytical Model Of Rotorcraft Aerodynamics and Dynamics (CAMRAD II), developed by Johnson Aeronautics of Palo Alto, Calif. The CA model is set up to use the generated PO-C81 tables from the C81 filtering process as described in FIG. 6, and predict the corresponding rotor performance. The CAMRAD II aerodynamic model for the rotor blade is based on lifting-line theory, using steady two-dimensional airfoil characteristics, a vortex wake model, and additional models for unsteady flow (attached flow and dynamic stall) and yawed/swept flow. Effects of compressibility (Mach numbers) and viscosity (Reynolds number, stall, and drag) enter through airfoil table data: lift, drag, and moment coefficients of two-dimensional sections as function of angle of attack and Mach number, for the appropriate chord and atmosphere (density, temperature) to have correct Reynolds number variation with Mach number.

The rotor optimization results in a Pareto-optimal rotor set from which rotor geometries can be extracted for further analysis. As the Reynolds number in the PO-C81 decks (based on the initial chord estimate from the user) can be different from the actual Reynolds number (based on the chord of the optimized rotor planform), there is the possibility for a mismatch in performance between the optimized rotor performance and the actual rotor performance. Furthermore, the angle of attack distribution in the CAMRAD II case is used to trace back the airfoil geometries further allowing for discrepancies between the optimization output and the actual rotor performance. This is because CAMRAD II will interpolate angles of attack, while the PO-C81 decks technically represent discrete airfoils at specific angles of attack.

To verify the optimized rotor performance, a full set of C81 decks for the acquired airfoil and rotor geometries must be generated, to validate that the performance curves include the rotor design blade loading values. As the rotor blade shape is roughly known beforehand (for a particular solidity at least), the requirement to re-iterate the primary ELISA loop was not required for the use cases presented in this work. CAMRADII will query the C81 table for performance based on input Mach and angle of attack. Afterwards it will retrieve the section airfoil coefficients for that particular condition-resulting in geometry for the lowest possible drag corresponding to the lift of that entry. The airfoil geometry is now tied to the angle of attack as CAMRADII, based on lifting line theory, has no particular notion of airfoil geometry.

Further studies into possible efficient airfoil shapes were performed using ELISA and various types of ROAMX parameterizations. Of particular significance was the roamx-1301 parameterization because of relatively high attainable lift-to-drag ratio figures. The operating conditions were chosen to reflect those at r/R=0.75 as representative of the aerodynamics over the blade (Re=20,000 and M=0.60). The roamx-1301 airfoil geometry obtained for peak cₗ/c_{d} is presented in FIG. 9.

FIG. 9 is a schematic diagram illustrating a schematic representation of the flow physics of ‘roamx’-1301 based airfoils as shown. The sharp leading edge causes immediate separation of the boundary layer. The separated shear layer rapidly becomes unstable (a Kelvin-Helmholtz type instability, in absence of any small scales) and starts shedding large scale vortices.

The ‘roamx’-1301 parameterization resulted in an optimized airfoil with an ability to generate high lift-to-drag ratios compared to conventional airfoils at low Reynolds numbers. The flow physics shows that this airfoil shape promotes immediate and fixed separation of the boundary layer, in the first half of the airfoil (chord). This mechanism is either a sharp leading edge, a sharp feature, or a rapid change in the slope of the upper surface. The resulting separated shear layer will exhibit primary (inviscid) instabilities resulting in the shedding of large-scale spanwise vortices/structures.

The ‘roamx’-1301 parameterized airfoil is shaped ‘away from the mean trajectory of the separated shear layer’ in such a way that these instabilities have the time and space to develop. After the instabilities have developed, the aft section of the airfoil ‘is aligned’ with the mean trajectory of the resulting instabilities. This will align the trajectory of the large-scale vortices/structures with the airfoil upper surface and result in an attached boundary layer in time-averaged sense.

The mechanism to promote separation ensures separation of the boundary layer unaffected by changes in freestream turbulence or angle of attack near the operating conditions. This is in sharp contrast with conventional airfoil performance at low Reynolds numbers, especially with laminar separation bubbles on conventional airfoils.

A very small lead-edge radius (due to a sharp leading edge) allows for naturally thin airfoils, which significantly benefit performance at high subsonic Mach numbers-such as at outboard regions of rotors or propellers-without affecting the primary mechanism of generating increased efficiency. This is in sharp contrast to conventional airfoils who rely on large leading edge radii, specifically to avoid separation of the boundary layer.

The peak cₗ/c_{d} for the airfoil optimizations at the tip are compared to the clf5605 profile and the maximum relative change is around 42% at r/R=0.75. Thus, airfoil optimization using a ‘roamx’-1301 parameterization importantly resulted in airfoil lift-to-drag ratio increases of up to 42% over Ingenuity's clf5605 outboard airfoil for representative conditions at r/R≈0.75. Preliminary rotor optimization, constrained to Ingenuity rotor dimensions, predicted a Figure of Merit of 0.68 using these profiles outboard. This represents a significant improvement over the legacy Ingenuity airfoil and rotor geometry.

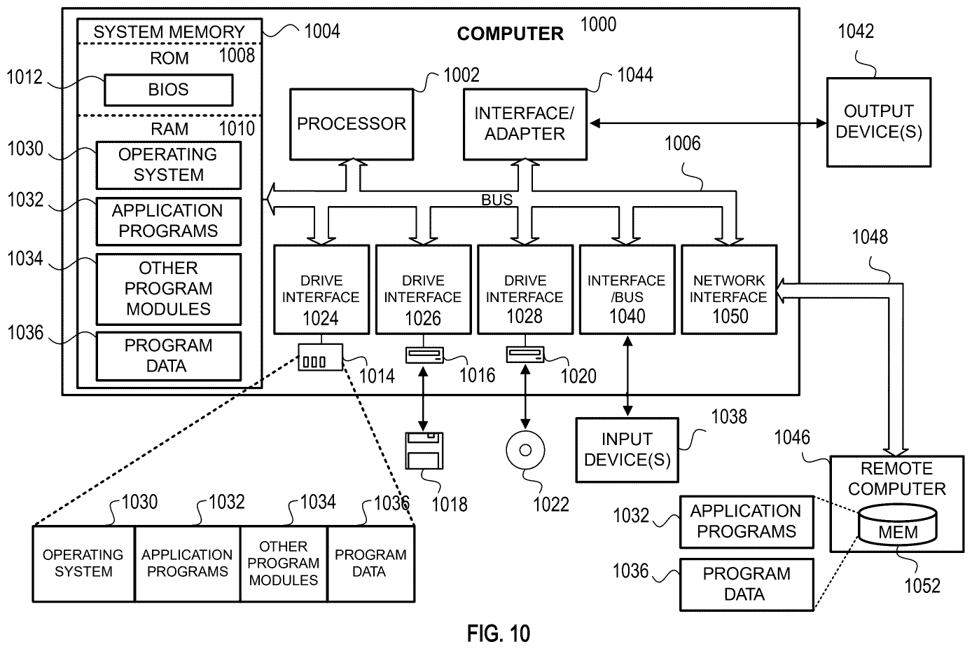

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 10. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the specified function. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 10 illustrates one example of a computer system 1000 that can be employed to execute one or more embodiments of the present disclosure. Computer system 1000 can be implemented on one or more general purpose networked computer systems, embedded computer systems, routers, switches, server devices, client devices, various intermediate devices/nodes or standalone computer systems. Additionally, computer system 1000 can be implemented on various mobile clients such as, for example, a personal digital assistant (PDA), laptop computer, pager, and the like, provided it includes sufficient processing capabilities.

Computer system 1000 includes processing unit 1002, system memory 1004, and system bus 1006 that couples various system components, including the system memory 1004, to processing unit 1002. System memory 1004 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 1002. System bus 1006 may be any of several types of bus structure including a memory bus or memory controller, a peripheral bus, and a local bus using any of a variety of bus architectures. System memory 1004 includes read only memory (ROM) 1008 and random-access memory (RAM) 1010. A basic input/output system (BIOS) 1012 can reside in ROM 1008 containing the basic routines that help to transfer information among elements within computer system 1000.

Computer system 1000 can include a hard disk drive 1014, magnetic disk drive 1016, e.g., to read from or write to removable disk 1018, and an optical disk drive 1020, e.g., for reading CD-ROM disk 1022 or to read from or write to other optical media. Hard disk drive 1014, magnetic disk drive 1016, and optical disk drive 1020 are connected to system bus 1006 by a hard disk drive interface 1024, a magnetic disk drive interface 1026, and an optical drive interface 1028, respectively. The drives and associated computer-readable media provide nonvolatile storage of data, data structures, and computer-executable instructions for computer system 1000. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and ROM 1008, including operating system 1030, one or more application programs 1032, other program modules 1034, and program data 1036. In some examples, the application programs 1032 can include the genetic evolution module 102, geometry parameterization module 104, Pareto-optimal set generation module 106, bin selection module 108, Parato-optimal C81 deck filtering module 110, computational fluid dynamics (CFD) module 111, airfoil performance function evaluation module 113, and rotor performance function evaluation module 115.

The application programs 1032 and program data 1036 can include functions and methods programmed to generate a set of optimized airfoil and rotor and to generate sets of airfoils based on ‘roamx’ parameterizations storing into a database of simulation data to undergo fitness evaluation, such as shown and described herein.

A user may enter commands and information into computer system 1000 through one or more input device 1038, such as a pointing device (e.g., a mouse, touch screen), keyboard, microphone, joystick, game pad, scanner, and the like. The input device 1038 can enable a user to modify or enter the user-defined inputs 1010, the primary flight conditions, location-based conditions, and ‘roamx’ parameterization, as well as any genetic operators requiring user input, and any combination thereof. These and other input devices 1038 are often connected to processing unit 1002 through a corresponding port interface 1040 that is coupled to the system bus, but may be connected by other interfaces, such as a parallel port, serial port, or universal serial bus (USB). One or more output devices 1042 (e.g., display, a monitor, printer, projector, or other type of displaying device) is also connected to system bus 1006 via interface 1044, such as a video adapter.

Computer system 1000 may operate in a networked environment using logical connections to one or more remote computers, such as remote computer 1046. Remote computer 1046 may be a workstation, computer system, router, peer device, or other common network node, and typically includes many or all the elements described relative to computer system 1000. The logical connections, schematically indicated at 1048, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 1000 can be connected to the local network through a network interface or adapter 1050. When used in a WAN networking environment, computer system 1000 can include a modem, or can be connected to a communications server on the LAN. The modem, which may be internal or external, can be connected to system bus 1006 via an appropriate port interface. In a networked environment, application programs 1032 or program data 1036 depicted relative to computer system 1000, or portions thereof, may be stored in a remote memory storage device 1052.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A computer-implemented method for determining multi-objective optimized airfoil geometries and rotor geometries, the computer-implemented method comprising the steps of:
receiving an input of a ‘roamx’ parameterization expressing at least a number nodes of one or more airfoil geometric parameters, and order of Bézier curves;
generating a random set of airfoils according to one or more decision variables based on the ‘roamx’ parameterization and an angle of attack;
initiating a genetic evolution module, and selecting by the genetic evolution module airfoil geometries from the randomly generated set of airfoils, wherein the selecting is based on evaluating a fitness of each of the randomly generated airfoils;
applying a genetic operation to the selected airfoils to generate a next generation set of airfoils;
repeating the selecting and evaluating until a sufficient convergence is determined along a Pareto-optimal front;
generating a final Pareto-optimal set of airfoils having the ‘roamx’ parameterization upon the determination of convergence.

2. The computer-implemented method of claim 1, further comprising:
receiving an input of a ‘roamx’ rotor parameterization expressing at least a number nodes of one or more rotor parameters, and order of Bezier curves, wherein the one or more rotor parameters includes a twist, a planform, or a thrust-weighted solidity;
generating a random set of rotor geometries according to one or more decision variables based on the ‘roamx’ parameterization;
initiating the genetic evolution module, and selecting by the genetic evolution module rotor geometries, wherein the selecting is based evaluating a rotor performance of each of the set of rotor geometries;
applying a genetic operation to the selected rotor geometries to generate a next generation set of rotor geometries;
repeating the selecting and evaluating until a sufficient convergence is determined along a Pareto-optimal front;
generating a final Pareto-optimal set of rotor geometries having the ‘roamx’ parameterization upon the determination of convergence.

3. The computer-implemented method of claim 1, wherein the ‘roamx’ parameterization is roamx-1301.

4. The computer-implemented method of claim 1, wherein the decision variables include at least an angle of attack, a first pair of Bézier control points for camber, and a second pair of Bézier control points for thickness.

5. The computer-implemented method of claim 1, wherein the evaluating a fitness is performed using a computation fluid dynamics solver.

6. The computer-implemented method of claim 1, wherein the evaluating a rotor performance is performed using a Comprehensive Analyses (CA) code.
